(19) United States
(12) Patent Application Publication
(10) Pub. No.: US 2022/0245858 A1
(43) Pub. Date: Aug. 4, 2022

(54) INTERACTION METHOD AND INTERACTION SYSTEM BETWEEN REALITY AND VIRTUALITY

(71) Applicants: Dai-Yun Tsai, Taipei City (TW); Kai-Yu Lei, Taipei City (TW); Po-Chun Liu, Taipei City (TW); Yi-Ching Tu, Taipei City (TW)

(72) Inventors: Dai-Yun Tsai, Taipei City (TW); Kai-Yu Lei, Taipei City (TW); Po-Chun Liu, Taipei City (TW); Yi-Ching Tu, Taipei City (TW)

(73) Assignee: COMPAL ELECTRONICS, INC., Taipei City (TW)

(21) Appl. No.: 17/586,704

(22) Filed: Jan. 27, 2022

Related U.S. Application Data
(60) Provisional application No. 63/144,953, filed on Feb. 2, 2021.

(51) Int. Cl. G06T 7/73; G06T 19/00; G06F 3/04815; G06V 30/146

(52) U.S. Cl. CPC G06T 7/74; G06V 30/1468; G06F 3/04815; G06T 19/006

(57) ABSTRACT

An interaction method between reality and virtuality and an interaction system between reality and virtuality are provided in the embodiments of the present invention. A marker is provided on a controller. A computing apparatus is configured to determine control position information of the controller in a space according to the marker in an initial image captured by an image capturing apparatus; determine object position information of a virtual object image in the space corresponding to the marker according to the control position information; and integrate the initial image and the virtual object image according to the object position information, to generate an integrated image. The integrated image is used to be played on a display. Accordingly, an intuitive operation is provided.

### CROSS REFERENCE TO RELATED APPLICATION

This application claims the priority benefit of U.S. provisional application Ser. No. 63/144,953, filed on Feb. 2, 2021. The entirety of the above-mentioned patent application is hereby incorporated by reference herein and made a part of specification.

### BACKGROUND

### Technical Field

The present invention relates to an extended reality (XR), and more particularly, to an interaction method between reality and virtuality and an interaction system between reality and virtuality.

### Related Art

Augmented Reality (AR) allows the virtual world on the screen to be combined and interact with the real world scenes. It is worth noting that existing AR imaging applications lack the control function of the display screen. For example, there is no control over the changes of AR image, and only the position of virtual objects may be dragged. For another example, in a remote conference application, if a presenter moves in a space, he cannot independently control the virtual object, and the objects need to be controlled on a user interface by someone else.

### SUMMARY

In view of this, embodiments of the present invention provide an interaction method between reality and virtuality and an interaction system between reality and virtuality, in which the interactive function of a virtual image is controlled by a controller.

The interaction system between reality and virtuality according to the embodiment of the present invention includes (but is not limited to) a controller, an image capturing apparatus, and a computing apparatus. The controller is provided with a marker. The image capturing apparatus is configured to capture an image. The computing apparatus is coupled to the image capturing apparatus. The computing apparatus is configured to determine control position information of the controller in a space according to the marker in an initial image captured by the image capturing apparatus; determine object position information of a virtual object image corresponding to the marker in the space according to the control position information; and integrate the initial image and the virtual object image according to the object position information, to generate an integrated image. The integrated image is used to be played on a display.

The interaction method between reality and virtuality according to the embodiment of the present invention includes (but is not limited to) following steps: control position information of a controller in a space is determined according to a marker captured by the initial image; object position information of a virtual object image corresponding to the marker in the space is determined according to the control position information; and the initial image and the virtual object image are integrated according to the object position information, to generate an integrated image. The controller is provided with a marker. The integrated image is used to be played on a display.

Based on the above, according to the interaction method between reality and virtuality and the interaction system between reality and virtuality according to the embodiments of the present invention, the marker on the controller is used to determine the position of the virtual object image, and generate an integrated image accordingly. Thereby, a presenter may change the motions or variations of the virtual object by moving the controller.

In order to make the above-mentioned features and advantages of the present invention more obvious and easy to understand, the following embodiments are given, together with the accompanying drawings, for detailed description as follows.

### BRIEF DESCRIPTION OF THE DRAWINGS

FIG. 1 is a schematic view of an interaction system between reality and virtuality according to an embodiment of the present invention.

FIG. 2 is a schematic view of a controller according to an embodiment of the present invention.

FIGS. 3A-3D are schematic views of a marker according to an embodiment of the present invention.

FIG. 4A is a schematic view illustrating a controller in combination with a marker according to an embodiment of the present invention.

FIG. 4B is a schematic view illustrating a controller in combination with a marker according to an embodiment of the present invention.

FIG. 5 is a schematic view illustrating a controller in combination with a marker according to an embodiment of the present invention.

FIGS. 6A-6I are schematic views of a marker according to an embodiment of the present invention.

FIG. 7A is a schematic view illustrating a controller in combination with a marker according to an embodiment of the present invention.

FIG. 7B is a schematic view illustrating a controller in combination with a marker according to an embodiment of the present invention.

FIG. 8 is a schematic view of an image capturing apparatus according to an embodiment of the present invention.

FIG. 9 is a flowchart of an interaction method between reality and virtuality according to an embodiment of the present invention.

FIG. 10 is a schematic view illustrating an initial image according to an embodiment of the present invention.

FIG. 11 is a flow chart of the determination of control position information according to an embodiment of the present invention.

FIG. 12 is a schematic view of a moving distance according to an embodiment of the present invention.

FIG. 13 is a schematic view illustrating a positional relationship between a marker and a virtual object according to an embodiment of the present invention.

FIG. 14 is a schematic view illustrating an indication pattern and a virtual object according to an embodiment of the present invention.

FIG. 15 is a flow chart of the determination of control position information according to an embodiment of the present invention.

FIG. 16 is a schematic view of specified positions according to an embodiment of the present invention.

FIG. 17A is a schematic view of a local image according to an embodiment of the present invention.

FIG. 17B is a schematic view of an integrated image according to an embodiment of the present invention.

FIG. 18A is a schematic view illustrating an integrated image with an exploded view integrated according to an embodiment of the present invention.

FIG. 18B is a schematic view of an integrated image with a partial enlarged view integrated according to an embodiment of the present invention.

FIG. 19A is a schematic view illustrating an off-camera situation according to an embodiment of the present invention.

FIG. 19B is a schematic view illustrating correction of the off-camera situation according to an embodiment of the present invention.

### DESCRIPTION OF THE EMBODIMENTS

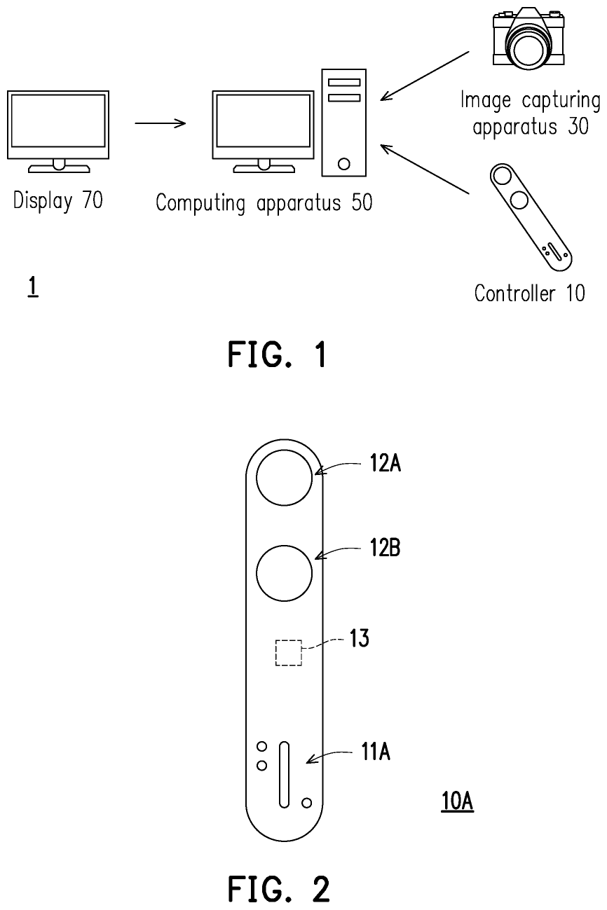

FIG. 1 is a schematic view of an interaction system 1 between reality and virtuality according to an embodiment of the present invention. Referring to FIG. 1, the interaction system 1 between reality and virtuality includes (but is not limited to) a controller 10, an image capturing apparatus 30, a computing apparatus 50 and a display 70.

The controller 10 may be a handheld remote control, joystick, gamepad, mobile phone, wearable device, or tablet computer. In some embodiments, the controller 10 may also be paper, woodware, plastic product, metal product, or other types of physical objects, and may be held or worn by a user.

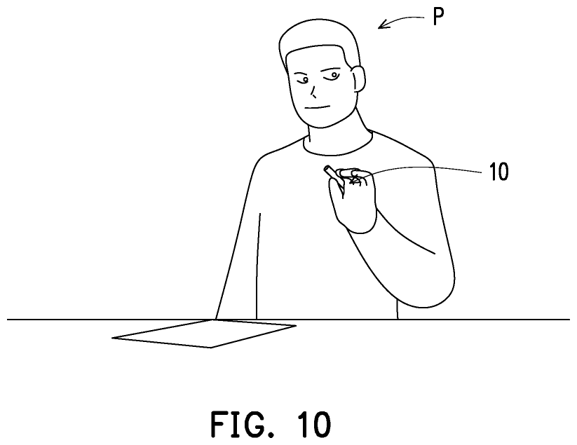

FIG. 2 is a schematic view of a controller 10A according to an embodiment of the present invention. Referring to FIG. 10A, the controller 10A is a handheld controller. The controller 10A includes input elements 12A and 12B and a motion sensor 13. The input elements 12A and 12B may be buttons, pressure sensors, or touch panels. The input elements 12A and 12B are configured to detect an interactive behavior (e.g. clicking, pressing, or dragging) of the user, and a control command (e.g. trigger command or action command) is generated accordingly. The motion sensor 13 may be a gyroscope, an accelerometer, an angular velocity sensor, a magnetometer, or a multi-axis sensor. The motion sensor 13 is configured to detect a motion behavior (e.g. moving, rotating, waving or swinging) of the user, and motion information (e.g. displacement, rotation angle, or speed in multiple axes) is generated accordingly.

In one embodiment, the controller 10A is further provided with a marker 11A.

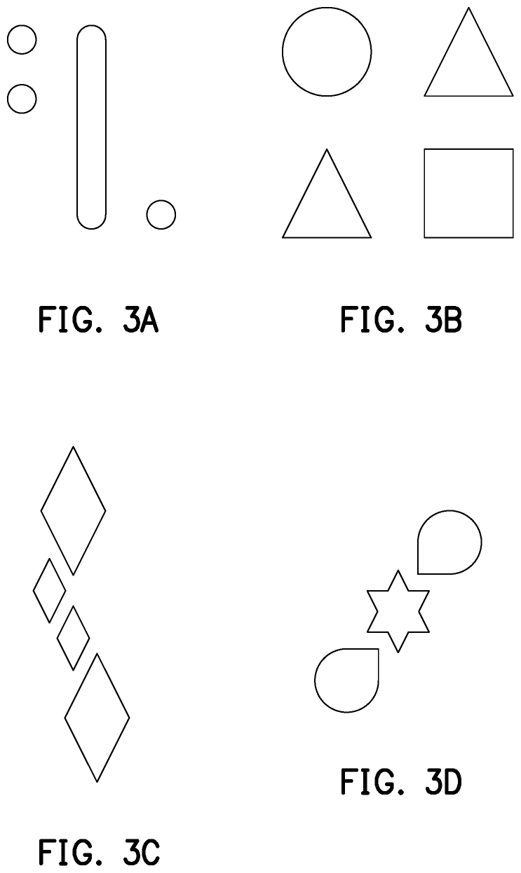

The marker has one or more words, symbols, patterns, shapes and/or colors. For example, FIGS. 3A to 3D are schematic views of a marker according to an embodiment of the present invention. Referring to FIG. 3A to FIG. 3D, different patterns represent different markers.

There are many ways in which the controller 10 may be combined with the marker.

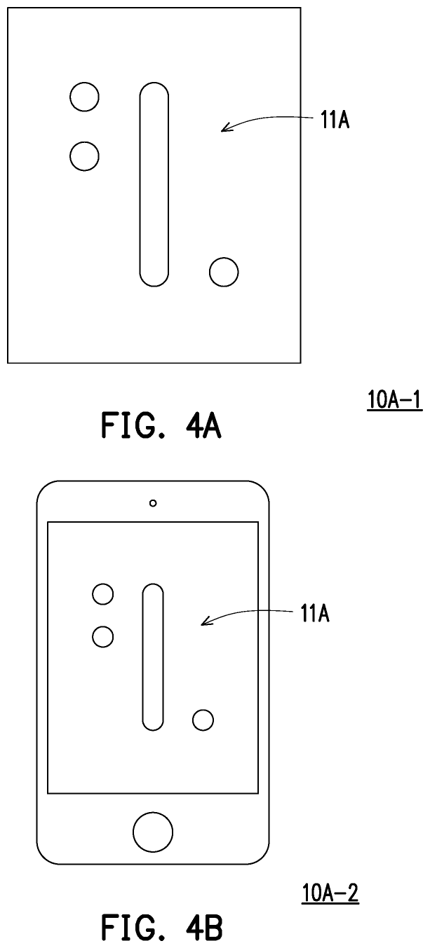

For example, FIG. 4A is a schematic view illustrating a controller 10A-1 in combination with the marker 10A according to an embodiment of the present invention. Referring to FIG. 4A, the controller 10A-1 is a piece of paper, and a marker 10A is printed on the piece of paper.

FIG. 4B is a schematic view illustrating a controller 10A-2 in combination with the marker 11A according to an embodiment of the present invention. Referring to FIG. 4B, the controller 10A-2 is a smart phone with a display. The display of the controller 10A-2 displays the image with the marker 11A.

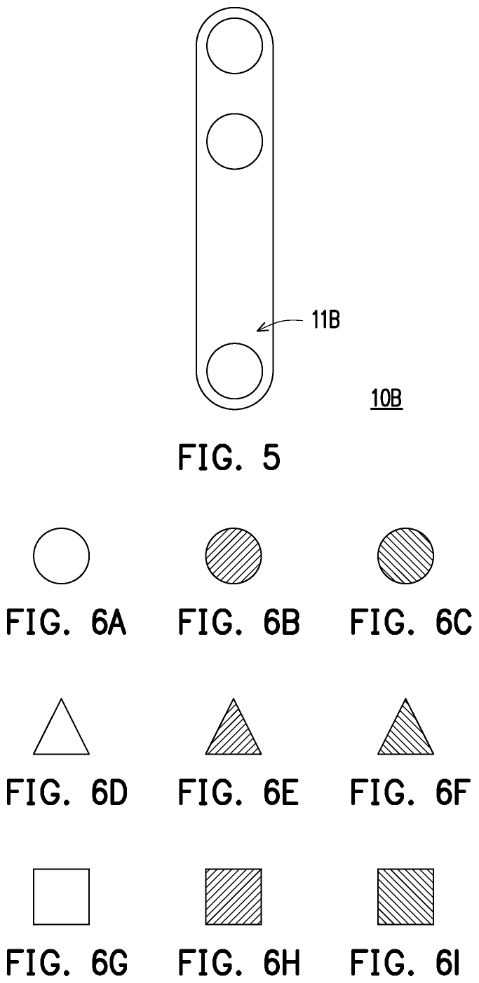

FIG. 5 is a schematic view illustrating a controller 10B in combination with a marker 11B according to an embodiment of the present invention. Referring to FIG. 5, the controller 10B is a handheld controller. A sticker of the marker 11B is attached to the display of the controller 10B.

FIGS. 6A-6I are schematic views of a marker according to an embodiment of the present invention. Referring to FIGS. 6A to 6I, the marker may be a color block of a single shape or a single color (the colors are distinguished by shading in the figure).

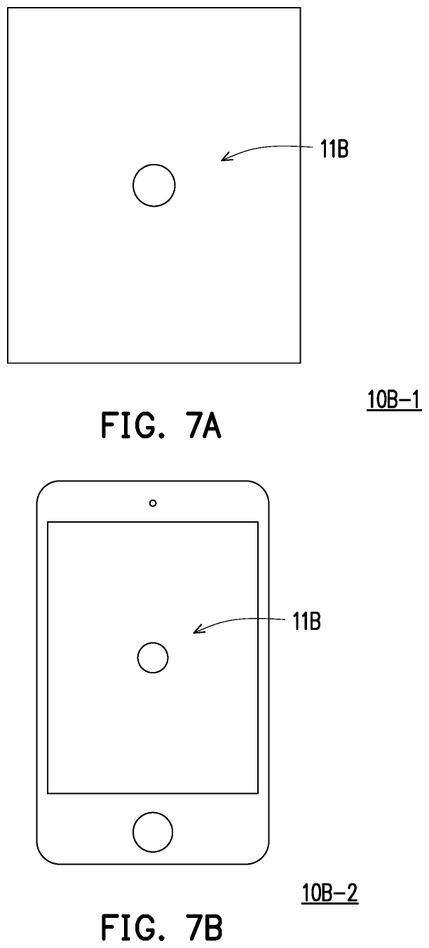

FIG. 7A is a schematic view illustrating a controller 10B-1 in combination with the marker 11B according to an embodiment of the present invention. Referring to FIG. 7A, the controller 10B-1 is a piece of paper, and the paper is printed with the marker 11B. Thereby, the controller 10B-1 may be selectively attached to devices such as notebook computers, mobile phones, vacuum cleaners, earphones, or other devices, and may even be combined with items that are expected to be demonstrated to customers.

FIG. 7B is a schematic view illustrating a controller in combination with a marker according to an embodiment of the present invention. Referring to FIG. 7B, a controller 10B-2 is a smart phone with a display. The display of the controller 10B-2 displays an image having the marker 11B.

It should be noted that the markers and controllers shown in the foregoing figures are only illustrative, and the appearances or types of the markers and controllers may still have other variations, which are not limited by the embodiments of the present invention.

The image capturing apparatus 30 may be a monochrome camera or a color camera, a stereo camera, a digital camera, a depth camera, or other sensors capable of capturing images. In one embodiment, the image capturing apparatus 30 is configured to capture images.

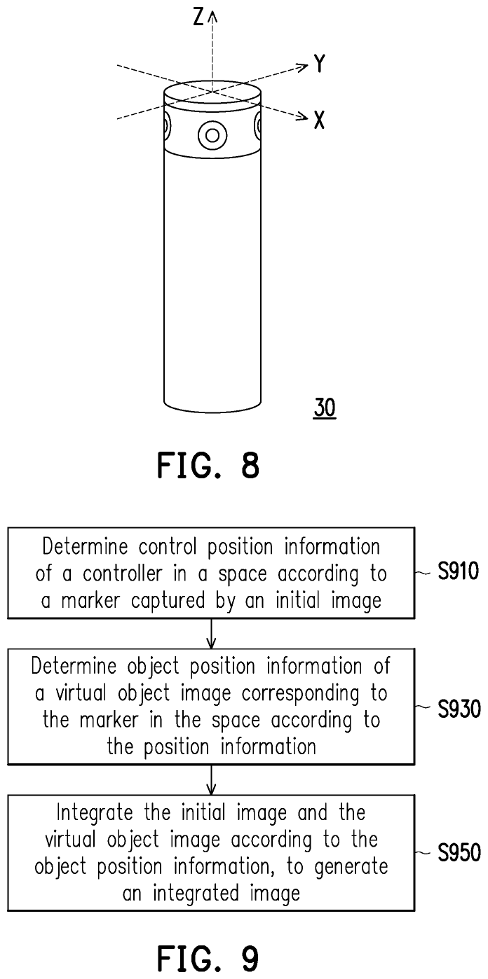

FIG. 8 is a schematic view of the image capturing apparatus 30 according to an embodiment of the present invention. Referring to FIG. 8, the image capturing apparatus 30 is a 360-degree camera, and may shoot objects or environments on three axes X, Y, and Z. However, the image capturing apparatus 30 may also be a fisheye camera, a wide-angle camera, or a camera with other fields of view.

The computing apparatus 50 is coupled to the image capturing apparatus 30. The computing apparatus 50 may be a smart phone, a tablet computer, a server, or other electronic devices with computing functions. In one embodiment, the computing apparatus 50 may receive images captured by the image capturing apparatus 30. In one embodiment, the computing apparatus 50 may receive a controllable command and/or a motion information of the controller 10.

The display 70 may be a liquid-crystal display (LCD), a light-emitting diode (LED) display, an organic light-emitting diode (OLED) display, or other displays. In one embodiment, the display 70 is configured to display images. In one embodiment, the display 70 is the display of a remote device in the scenario of a remote conference meeting. In another embodiment, the display 70 is a display of a local device in the scenario of a remote conference meeting.

Hereinafter, the method described in the embodiments of the present invention will be described in combination with various devices, elements, and modules of the interaction system 1 between reality and virtuality. Each process of the method may be adjusted according to the implementation situation, but is not limited thereto.

FIG. 9 is a flowchart of an interaction method between reality and virtuality according to an embodiment of the present invention. Referring to FIG. 9, the computing apparatus 50 determines control position information of the controller 10 in a space according to the marker captured by an initial image captured by the image capturing apparatus 30 (step S910). To be specific, the initial image is an image captured by the image capturing apparatus 30 within its field of view. In some embodiments, the captured image may be dewarped and/or cropped according to the field of view of the image capturing apparatus 30.

For example, FIG. 10 is a schematic view illustrating an initial image according to an embodiment of the present invention. Referring to FIG. 10, if a user P and the controller 10 are within the field of view of the image capturing apparatus 30, then the initial image includes the user P and the controller 10.

It should be noted that since the controller 10 is provided with a marker, the initial image may further include the marker. The marker may be used to determine the position of the controller 10 in the space (referred to as the control position information). The control position information may be coordinates, moving distance and/or orientation (or attitude).

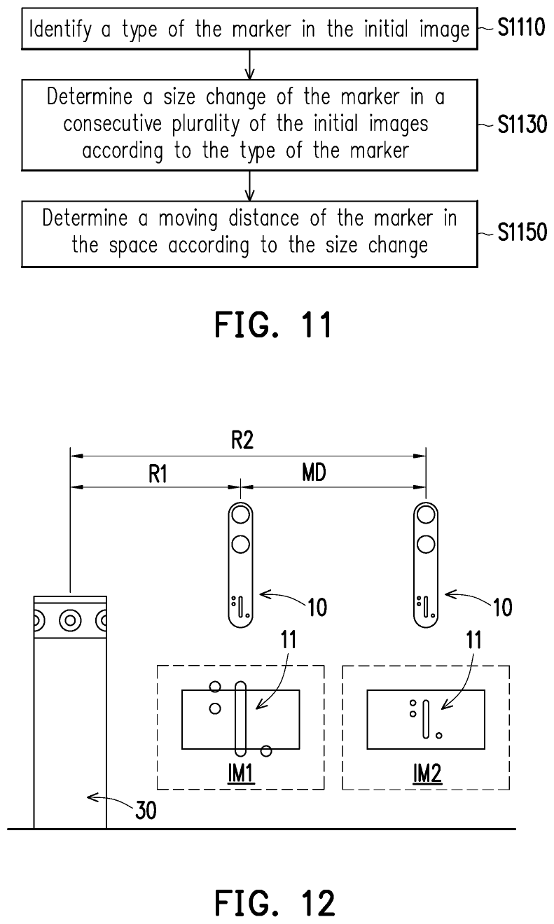

FIG. 11 is a flow chart of the determination of control position information according to an embodiment of the present invention. Referring to FIG. 11, the computing apparatus 50 may identify a type of the marker in the initial image (step S1110). For example, the computing apparatus 50 implement object detection based on a neural network algorithm (e.g. YOLO, convolutional neural network (R-CNN); fast region-based CNN) or feature-based matching algorithm (e.g. histogram of oriented gradient (HOG); Harr; or feature matching of speeded up robust features (SURF)), thereby inferring the tape of the marker accordingly.

In one embodiment, the computing apparatus 50 may identify the type of the marker according to the pattern and/or color of the marker (FIGS. 2 to 7). For example, the patterns shown in FIG. 3A and the color blocks shown in FIG. 6A represent different types, respectively.

In one embodiment, different types of marker represent different types of virtual object images. For example, FIG. 3A represents a product A, and FIG. 3B represents a product B.

The computing apparatus 50 may determine a size change of the marker in a consecutive plurality of the initial images according to the type of the marker (step S1130). To be specific, the computing apparatus 50 may respectively calculate the size of the markers in the initial images captured at different time points, and determine the size change accordingly. For example, the computing apparatus 50 calculates the side length difference between the markers in two initial images on the same side. For another example, the computing apparatus 50 calculates the area difference of the markers in two initial images.

The computing apparatus 50 may record in advance the sizes (possibly related to length, width, radius, or area) of a specific marker at a plurality of different positions in a space, and associate these positions with the sizes in the image. Then, the computing apparatus 50 may determine the coordinates of the marker in the space according to the size of the marker in the initial image, and take the coordinates as the control position information accordingly. Further, the computing apparatus 50 may record in advance the attitudes of a specific marker at a plurality of different positions in the space, and associate these attitudes with the morphings in the image. Then, the computing apparatus 50 may determine the morphing of the marker in the space according to the morphing of the marker in the initial image, and use the same as the control position information.

The computing apparatus 50 may determine a moving distance of the marker in the space according to the size change (step S1150). To be specific, the control position information includes the moving distance. The size of the marker in the image is related to the depth of the marker relative to the image capturing apparatus 30. For example, FIG. 12 is a schematic view of a moving distance according to an embodiment of the present invention. Referring to FIG. 12, a distance R1 between the controller 10 at a first time point and the image capturing apparatus 30 is smaller than a distance R2 between the controller 10 at a second time point and the image capturing apparatus 30. An initial image IM1 is a partial image of the controller 10 captured by the image capturing apparatus 30 away from the distance R1. An initial image IM2 is a partial image of the controller 10 captured by the image capturing apparatus 30 away from the distance R2. Since the distance R2 is greater than the distance R1, the size of a marker 11 in the initial image IM2 is smaller than the size of the marker 11 in the initial image IM1. The computing apparatus 50 may calculate the size change between the marker 11 in the initial image IM2 and the marker 11 in the initial image IM1, and obtain a moving distance MD accordingly.

In addition to the moving distance in depth, the computing apparatus 50 may determine the displacement of the marker on the horizontal axis and/or the vertical axis in different initial images based on the depth of the marker, and obtain the moving distance of the marker on the horizontal axis and/or vertical axis in the space accordingly.

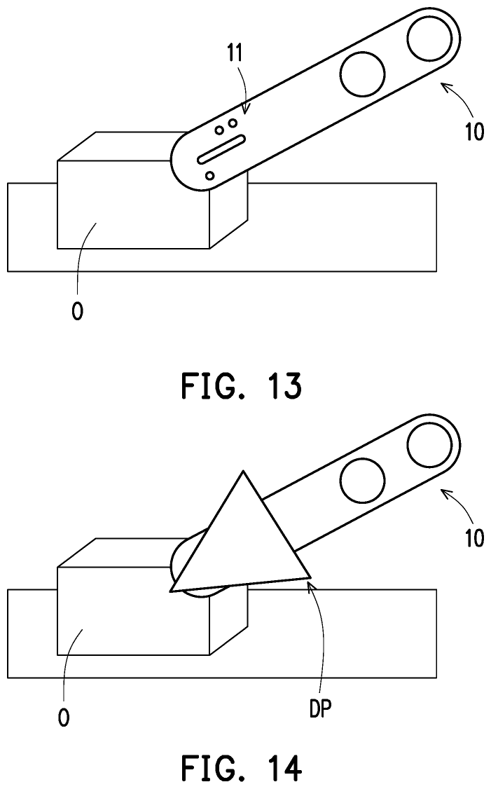

For example, FIG. 13 is a schematic view illustrating a positional relationship between the marker 11 and an object O according to an embodiment of the present invention. Referring to FIG. 13, the object O is located at the front end of the marker 11. Based on the identification result of the initial image, the computing apparatus 50 may obtain the positional relationship between the controller 10 and the object O.

In one embodiment, the motion sensor 13 of the controller 10A of FIG. 2 generates first motion information (e.g. displacement, rotation angle, or speed in multiple axes). The computing apparatus 50 may determine the control position information of the controller 10A in the space according to the first motion information. For example, a 6-DoF sensor may obtain position and rotation information of the controller 10A in the space. For another example, the computing apparatus 50 may estimate the moving distance of the controller 10A through double integral of the acceleration of the controller 10A in the three axes.

Referring to FIG. 9, the computing apparatus 50 determines the object position information of the virtual object image corresponding to the marker in the space according to the position information (step S930). To be specific, the virtual object image is an image of a digital virtual object. The object position information may be the coordinates, moving distance and/or orientation (or attitude) of the virtual object in the space. The control position information of the marker is used to indicate the object position information of the virtual object. For example, the coordinates in the control position information are directly used as the object position information. For another example, the position at a certain spacing from the coordinates in the control position information is used as the object position information.

The computing apparatus 50 integrates the initial image and the virtual object image according to the object position information to generate an integrated image (step S950). To be specific, the integrated image is used as the image to be played on the display 70. The computing apparatus 50 may determine the position, motion state, and attitude of the virtual object in the space according to the object position information, and integrate the corresponding virtual object image with the initial image, such that the virtual object is presented in the integrated image. The virtual object image may be static or dynamic, and may also be a two-dimensional image or a three-dimensional image.

In one embodiment, the computing apparatus 50 may convert the marker in the initial image into an indication pattern. The indication pattern may be an arrow, a star, an exclamation mark, or other patterns. The computing apparatus 50 may integrate the indication pattern into the integrated image according to the control position information. The controller 10 may be covered or replaced by the indication pattern in the integrated image. For example, FIG. 14 is a schematic view illustrating an indication pattern DP and the object O according to an embodiment of the present invention. Referring to FIG. 13 and FIG. 14, the marker 11 in FIG. 13 is converted into the indication pattern DP. In this manner, it is convenient for the viewer to understand the positional relationship between the controller 10 and the object O.

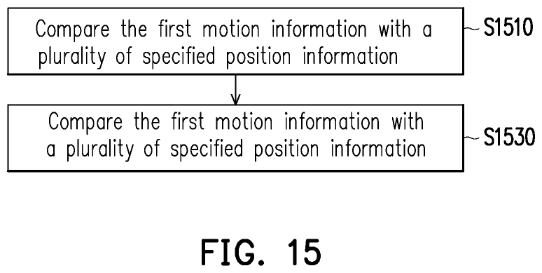

In addition to directly reflect the object position information by the control position information of the controller 10, one or more specified object positions are also used for positioning. FIG. 15 is a flow chart of the determination of control position information according to an embodiment of the present invention. Referring to FIG. 15, the computing apparatus 50 may compare the first motion information with a plurality of specified position information (step S1510). Each specified position information corresponds to a second motion information generated by a specified position of the controller 10 in the space. Each of the specified position information records a spatial relationship of the controller 10 between the specified position and the object.

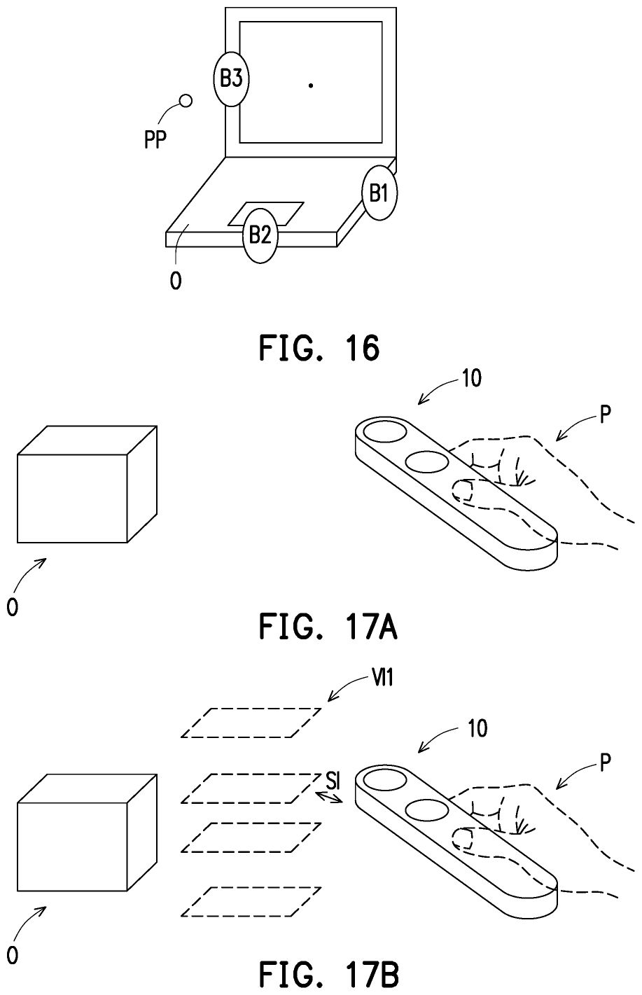

For example, FIG. 16 is a schematic view of specified positions B1 to B3 according to an embodiment of the present invention. Referring to FIG. 16, the object O is a notebook computer as an example. The computing apparatus 50 may define specified positions B1-B3 in the image, and record in advance (corrected) motion information (which may be directly used as the second motion information) of the controller 10 at these specified positions B1-B3. Therefore, by comparing the first and second motion information, it may be determined whether the controller 10 is located at or close to the specified positions B1 to B3 (i.e. the spatial relationship).

Referring to FIG. 15, the computing apparatus 50 may determine the control position information according to the comparison result of the first motion information and one of the specified position information corresponding to a specified position closest to the controller 10 (step S1530). Taking FIG. 16 as an example, the computing apparatus 50 may record the specified position B1 or a position within a specified range therefrom as specified position information. As long as the first motion information measured by the arithmetic sensor 13 matches the specified position information, it is considered that the controller 10 intends to select the specified position. That is to say, the control position information in this embodiment represents the position pointed by the controller 10.

In one embodiment, the computing apparatus 50 may integrate the initial image and a prompt pattern pointed by the controller 10 according to the control position information, to generate a local image. The prompt patterns may be dots, arrows, stars, or other patterns. Taking FIG. 16 as an example, a prompt pattern PP is a small dot. It is worth noting that the prompt pattern is located at the end of a ray cast or extension line extended by the controller 10. That is to say, the controller 10 does not necessarily need to be at or close to the specified position, as long as the laser projection or the end of the extension line of the controller 10 is at the specified position, it also means that the controller 10 intends to select the specified position. The local image of the integrated prompt pattern PP may be adapted to be played on the display 70 of the local device (e.g. for the presenter to view). In this manner, it is convenient for the presenter to know the position selected by the controller 10.

In one embodiment, the specified positions correspond to different virtual object images. Taking FIG. 16 as an example, the specified position B1 represents a presentation C, the specified position B2 represents the virtual object of the processor, and the specified position B3 represents a presentation D to a presentation F.

In one embodiment, the computing apparatus 50 may set a spacing between the object position information and the control position information in the space. For example, the coordinates of the object position information and the control position information are separated by 50 cm, such that there is a certain distance between the controller 10 and the virtual object in the integrated image.

For example, FIG. 17A is a schematic view of a local image according to an embodiment of the present invention. Referring to FIG. 17A, in an exemplary application scenario, the local image is for viewing by the user P who is the presenter. The user P only needs to see the physical object O and the physical controller 10. 17B is a schematic view of an integrated image according to an embodiment of the present invention. Referring to FIG. 17B, in an exemplary application scenario, the integrated image us for viewing by a remote viewer. There is a spacing SI between a virtual object image VI1 and the controller 10. In this manner, the virtual object image VI1 may be prevented from being obscured.

In one embodiment, the computing apparatus 50 may generate a virtual object image according to an initial state of the object. This object may be virtual or physical. It is worth noting that the virtual object image presents a change state of the object. The change state is one of the initial state changes in position, pose, appearance, decomposition, and file options. For example, the change state is zooming, moving, rotating, exploded view, partial enlargement, partial exploded view of parts, internal electronic parts, color change, material change, etc. of the object.

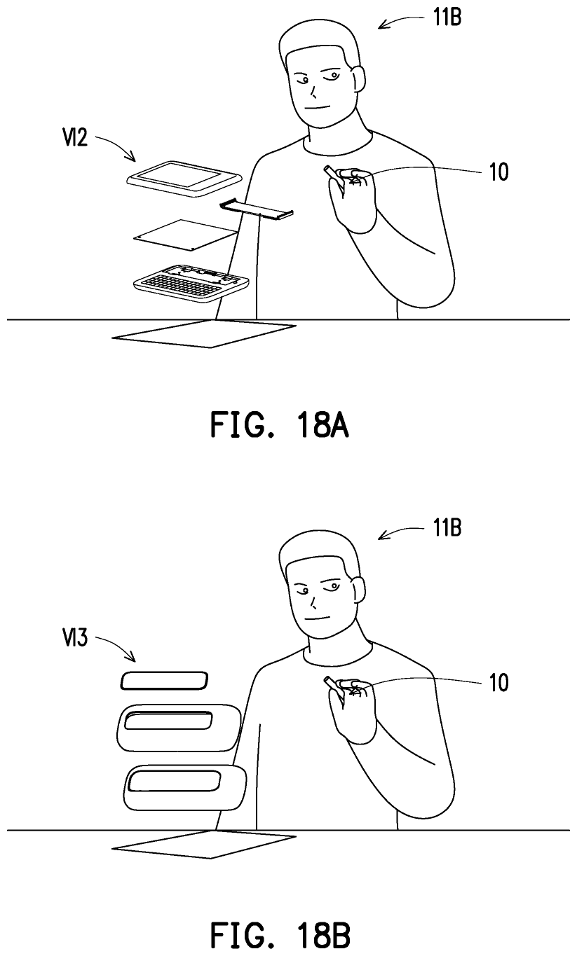

The integrated image may present the changed virtual object image of the object. For example, FIG. 18A is a schematic view illustrating an integrated image with an exploded view integrated according to an embodiment of the present invention. Referring to FIG. 18A, a virtual object image VI2 is an exploded view. FIG. 18B is a schematic view with an integrated image with a partial enlarged view integrated according to an embodiment of the present invention. Referring to FIG. 18B, a virtual object image VI3 is a partially enlarged view.

In one embodiment, the computing apparatus 50 may generate the trigger command according to an interactive behavior of the user. The interactive behavior may be detected by the input element 12A shown in FIG. 2. Interactive behaviors may be actions such as pressing, clicking, and sliding. The computing apparatus 50 determines whether the detected interaction behavior matches a preset trigger behavior. If it matches the preset trigger behavior, the computing apparatus 50 generates the trigger command.

The computing apparatus 50 may start a presentation of the virtual object image in the integrated image according to the trigger command. That is to say, if it is detected that the user is operating the preset trigger behavior, the virtual object image will only appear in the integrated image. If it is not detected that the user is operating the preset trigger behavior, the presentation of the virtual object image is interrupted.

In one embodiment, the trigger command is related to whole or part of the object corresponding to the control position information. The virtual object image is related to the object or part of the object corresponding to the control position information. In other words, the preset trigger behavior is used to confirm a target that the user intends to select. The virtual object image may be the change state, presentation, file, or other content of the selected object, and may correspond to a virtual object identification code (for retrieval from the object database).

Taking FIG. 16 as an example, the specified position B1 corresponds to three files. If the prompt pattern PP is located at the specified position B1 and the input element 12A detects a pressing action, the virtual object image is the content of the first file. Then, the input element 12A detects the next pressing action, and the virtual object image is the content of the second file. Finally, the input element 12A detects the next pressing action, and the virtual object image is the content of the third file.

In one embodiment, the computing apparatus 50 may generate an action command according to the interactive behavior of the user. The interactive behavior may be detected by the input element 12B shown in FIG. 2. The interactive behaviors may be an action such as pressing, clicking, and sliding. The computing apparatus 50 determines whether the detected interaction behavior matches a preset action behavior. If it matches the preset action behavior, the computing apparatus 50 generates the action command.

The computing apparatus 50 may determine the change state of the object in the virtual object image according to the action command. That is to say, the virtual object image will show the change state of the object only when it is detected that the user is operating the preset action behavior. If it is not detected that the user is operating the preset action behavior, the original state of the object is present.

In one embodiment, the action command is related to the motion state of the control position information. The content of the change state may correspond to the change of the motion state corresponding to the control position information. Taking FIG. 13 as an example, if the input element 12B of FIG. 2 detects a pressing action and the motion sensor 13 detects that the controller 10 moves, the virtual object image is the dragged object O. For another example, if the input element 12B detects a pressing action and the motion sensor 13 detects that the controller 10 rotates, the virtual object image is the rotated object O. For yet another example, if the input element 12B detects a pressing behavior and the motion sensor 13 detects that the controller 10 moves forward or backward, the virtual object image is the zooming object O.

In one embodiment, the computing apparatus 50 may determine a first image position of the controller 10 in the integrated image according to the control position information, and change the first image position into a second image position. The second image position is a region of interest in the integrated image. To be specific, in order to prevent the controller 10 or the user from being far from the field of view of the initial image, the computing apparatus 50 may set the region of interest in the initial image. The computing apparatus 50 may determine whether the first image position of the controller 10 is within the region of interest. If it is within the region of interest, the computing apparatus 50 maintains the position of the controller 10 in the integrated image. If it is not located in the area of interest, the computing apparatus 50 changes the position of the controller 10 in the integrated image, and the controller 10 in the changed integrated image is located in the area of interest. For example, if the image capturing apparatus 30 is a 360-degree camera, the computing apparatus 50 may change the field of view of the initial image such that the controller 10 or the user is located in the cropped initial image.

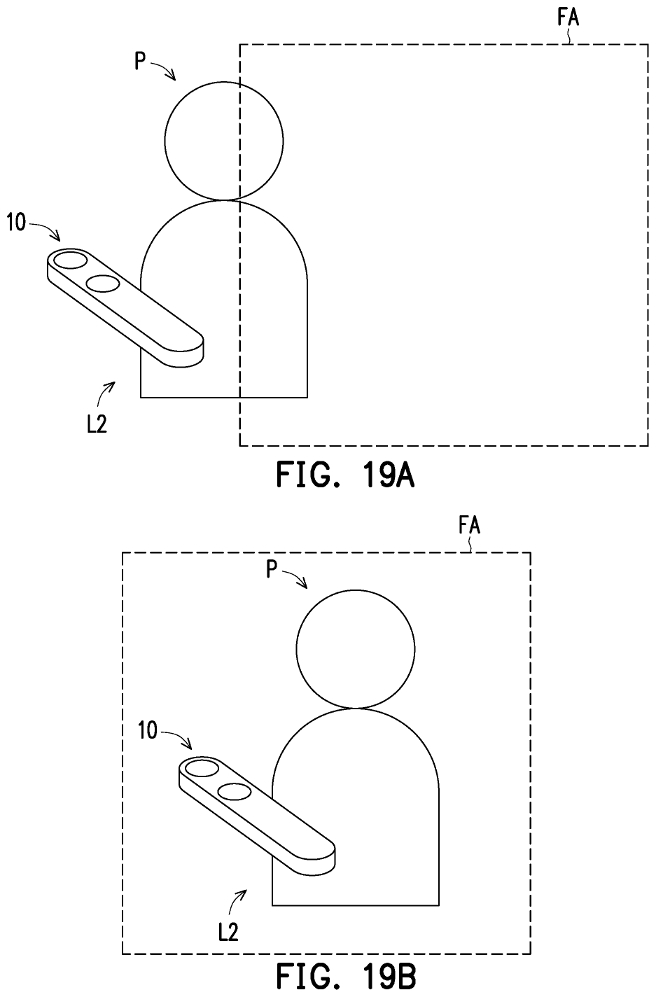

For example, FIG. 19A is a schematic view illustrating an off-camera situation according to an embodiment of the present invention. Referring to FIG. 19A, when the controller 10 is located at the first image position, the controller 10 and part of the user P is outside a region of interest FA. FIG. 19B is a schematic view illustrating correction of off-camera situation according to an embodiment of the present invention. Referring to FIG. 19B, the position of the controller 10 is changed to a second image position L2 such that the controller 10 and the user P are located in the region of interest FA. At this time, the display of the client presents a screen in the region of interest FA as shown in FIG. 19B.

In summary, in the interaction method between reality and virtuality and the interaction system between reality and virtuality according to the embodiments of the present invention, a display function of controlling the virtual object image is provided by the controller in conjunction with the image capturing apparatus. The marker presented on the controller or the mounted motion sensor may be configured to determine the position of the virtual object or the change state of the object (e.g. zooming, moving, rotating, exploded view, zooming, appearance change, etc.). Thereby, intuitive operation can be provided.

Although the present invention has been disclosed above by the embodiments, the present invention is not limited thereto. Anyone with ordinary knowledge in the art can make some changes and modifications without departing from the spirit and scope of the present invention. Therefore, the protection scope of the present invention shall be determined by the appended claims.

What is claimed is:

1. An interaction system between reality and virtuality, the system comprising:
a controller, provided with a marker;
an image capturing apparatus, configured to capturing an image; and
a computing apparatus, coupled to the image capturing apparatus and configured to:
determine control position information of the controller in a space according to the marker in an initial image captured by the image capturing apparatus;
determine object position information of a virtual object image corresponding to the marker in the space according to the control position information; and
integrate the initial image and the virtual object image according to the object position information, to generate an integrated image, wherein the integrated image is used to be played on a display.

2. The interaction system between reality and virtuality according to claim 1, wherein the computing apparatus is further configured to:
identify a type of the marker in the initial image;
determine a size change of the marker in a consecutive plurality of the initial images according to the type of the marker; and
determine a moving distance of the marker in the space according to the size change, wherein the control position information comprises the moving distance.

3. The interaction system between reality and virtuality according to claim 2, wherein the computing apparatus is further configured to:
identify the type of the marker according to at least one of a pattern and a color of the marker.

4. The interaction system between reality and virtuality according to claim 1, wherein the controller further comprises a motion sensor, which is configured to generate a first motion information, and the computing apparatus is further configured to:
determine the control position information of the controller in the space according to the first motion information.

5. The interaction system between reality and virtuality according to claim 4, wherein the computing apparatus is further configured to:
compare the first motion information with a plurality of specified position information, wherein each of the specified position information corresponds to a second motion information generated by a specified position of the controller in the space, and each of the specified position information records a spatial relationship between the controller at the specified position and an object; and
determine the control position information according to a comparison result of the first motion information and one of the specified position information corresponding to a specified position closest to the controller.

6. The interaction system between reality and virtuality according to claim 1, wherein the computing apparatus is further configured to:
integrate the initial image and a prompt pattern pointed by the controller according to the control position information, to generate a local image.

7. The interaction system between reality and virtuality according to claim 1, wherein the computing apparatus is further configured to:
set a spacing between the object position information and the control position information in the space.

8. The interaction system between reality and virtuality according to claim 1, wherein the computing apparatus is further configured to:
generate the virtual object image according to an initial state of an object, wherein the virtual object image presents a change state of the object, which is one of the changes of the initial state in position, posture, appearance, decomposition, and file options, and the object is virtual or physical.

9. The interaction system between reality and virtuality according to claim 1, wherein the controller further comprises a first input element, wherein the computing apparatus is further configured to:
generate a trigger command according to an interactive behavior of a user detected by the first input element; and
start a presentation of the virtual object image in the integrated image according to the trigger command.

10. The interaction system between reality and virtuality according to claim 8, wherein the controller further comprises a second input element, wherein the computing apparatus is further configured to:
generate an action command according to an interactive behavior of a user detected by the second input element; and
determine the change state according to the action command.

11. The interaction system between reality and virtuality according to claim 1, wherein the computing apparatus is further configured to:
convert the marker into an indication pattern; and
integrate the indication pattern into the integrated image according to the control position information, wherein the controller is replaced by the indication pattern in the integrated image.

12. The interaction system between reality and virtuality according to claim 1, wherein the computing apparatus is further configured to:
determine a first image position of the controller in the integrated image according to the control position information; and
change the first image position into a second image position, wherein the second image position is a region of interest in the integrated image.

13. An interaction method between reality and virtuality, the method comprising:
determining control position information of a controller in a space according to a marker captured by an initial image, wherein the controller is provided with the marker;
determining object position information of a virtual object image corresponding to the marker in the space according to the control position information; and
integrating the initial image and the virtual object image according to the object position information, to generate an integrated image, wherein the integrated image is used to be played on a display.

14. The interaction method between reality and virtuality according to claim 13, wherein steps of determining the control position information comprise:
identifying a type of the marker in the initial image;
determining a size change of the marker in a consecutive plurality of the initial images according to the type of the marker; and
determining a moving distance of the marker in the space according to the size change, wherein the control position information comprises the moving distance.

15. The interaction method between reality and virtuality according to claim 14, wherein a step of identifying the type of the marker in the initial image comprises:
identifying the type of the marker according to at least one of a pattern and a color of the marker.

16. The interaction method between reality and virtuality according to claim 13, wherein the controller further comprises a motion sensor, which is configured to generate a first motion information, and a step of determining the control position information comprises:
determining the control position information of the controller in the space according to the first motion information.

17. The interaction method between reality and virtuality according to claim 16, wherein steps of determining the control position information comprise:
comparing the first motion information with a plurality of specified position information, wherein each of the specified position information corresponds to a second motion information generated by a specified position of the controller in the space, and each of the specified position information records a spatial relationship between the controller at the specified position and an object; and
determining the control position information according to a comparison result of the first motion information and one of the specified position information corresponding to a specified position closest to the controller.

18. The interaction method between reality and virtuality according to claim 13, the method further comprising:
integrating the initial image and a prompt pattern pointed by the controller according to the control position information, to generate a local image.

19. The interaction method between reality and virtuality according to claim 13, wherein a step of determining the object position information comprises:
setting a spacing between the object position information and the control position information in the space.

20. The interaction method between reality and virtuality according to claim 13, wherein a step of generating the integrated image comprises:
generating the virtual object image according to an initial state of an object, wherein the virtual object image presents a change state of the object, which is one of the changes of the initial state in position, posture, appearance, decomposition, and file options, and the object is virtual or physical.

21. The interaction method between reality and virtuality according to claim 13, wherein steps of generating the integrated image comprise:
generating a trigger command according to an interactive behavior of a user; and
starting a presentation of the virtual object image in the integrated image according to the trigger instruction.

22. The interaction method between reality and virtuality according to claim 20, wherein steps of generating the integrated image comprises:
generating an action command according to an interactive behavior of a user; and
determining the change state according to the action command.

23. The interaction method between reality and virtuality according to claim 13, wherein steps of generating the integrated image comprises:
converting the marker into an indication pattern; and
integrating the indication pattern into the integrated image according to the control position information, wherein the controller is replaced by the indication pattern in the integrated image.

24. The interaction method between reality and virtuality according to claim 13, wherein steps of generating the integrated image comprise:
determining a first image position of the controller in the integrated image according to the control position information; and
changing the first image position into a second image position, wherein the second image position is a region of interest in the integrated image.
